(19) United States
(12) Patent Application Publication
(10) Pub. No.: US 2022/0369207 A1
(43) Pub. Date: Nov. 17, 2022

(54) NETWORK NODE, METHOD FOR A NETWORK NODE, USER EQUIPMENT AND METHOD FOR USER EQUIPMENT FOR NETWORK SLICE USAGE CONTROL

(71) Applicant: NEC Corporation, Minato-ku, Tokyo (JP)

(72) Inventors: Iskren IANEV, Lower Earley (GB); Toshiyuki TAMURA, Tokyo (JP)

(73) Assignee: NEC Corporation, Minato-ku, Tokyo (JP)

(21) Appl. No.: 17/623,337

(22) PCT Filed: Jun. 29, 2020
(86) PCT No.: PCT/JP2020/025504

§ 371 Date: Dec. 28, 2021

(30) Foreign Application Priority Data
Jul. 9, 2019 (EP) 19185344.9

(51) Int. Cl. H04W 48/06; H04W 28/02

(52) U.S. Cl. CPC H04W 48/06; H04W 28/0231

(57) ABSTRACT

The invention proposes solutions for monitoring and controlling the maximum number of the UEs registered in a Network Slice, the maximum number of the established PDU Sessions in a Network Slice and the maximum number of the Uplink and Downlink data rates per UE in a Network Slice. The invention also enforces access and service restriction in a Network Slice when the Network Slice parameters boundaries have been reached.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to control of network slice usage in the so-called ‘5G’ (or ‘Next Generation’) systems.

### BACKGROUND ART

### Background

Network slicing features defined in 3GPP release 15 and release 16 enable a great variety of communication services for operators and verticals alike. To enhance the commercial viability of Network Slicing, GSMA SGJA has introduced in document NG.116 the concept of Generic Slice Template (GST) [3] from which several Network Slice Types descriptions can be derived. Some of the parameters in the GST point explicitly to the definition of parameters and bounds on the service delivered to the end customer. However, the enforcement of some of these bounds or of some of these parameters is not supported by the 5GS yet.

For instance, the GST aims at the limitation of the number of PDU sessions per slice, or the number of devices supported per network slice, or the maximum UL or DL data rate per network slice (which is not the same as the AMBR for a UE, rather a rate limitation per UE/S-NSSAI). These parameters cannot be enforced today as the system lacks the ability to do so.

The SA2 SID on Enhancement of Network Slicing Phase 2 [5] aims at identifying the gaps that need to be filled in providing support for the GST parameters enforcement and the suitable solution to address these gaps.

The objective of this study is to identify the gaps in the currently defined 5GS system procedures defined in SA2 owned Technical Specifications (TSs) to support of GST parameters and to study potential solutions that may address these gaps. The following parameters at least will be under consideration:

Maximum number of UEs per Network Slice

Maximum number of PDU sessions per Network Slice

Maximum UL and DL data rate per UE in a Network Slice

Interaction with SA1 and GSMA is expected for any aspects that need any clarification, as identified as the work progresses.

### SUMMARY OF INVENTION

### Technical Problem

### Problem Description

3GPP intends to identify the gaps in the currently defined 5GS to support GST parameters and provide related solutions while the detail of the related solutions is not disclosed, including the following issues:

Maximum number of UEs per Network Slice.

Maximum number of PDU sessions per Network Slice.

Maximum UL and DL data rate per UE in a Network Slice.

The 5G system shall support a mechanism to configure a specific geographic area in which an authorized UE is able to access the network slice.

The following embodiments aim to address one or more of the above issues.

### Solution to Problem

According to an aspect of the present disclosure, a network node for network slice management, includes: means for receiving a request regarding a network slice from a User Equipment, UE; and means for determining whether the network node for network slice management accepts the request based on information regarding use of resource of the network slice.

According to another aspect of the present disclosure, a network node for network slice management, includes: means for receiving a request regarding a network slice; means for removing information corresponding to the request regarding the network slice; and means for updating information regarding use of resource of the network slice.

According to another aspect of the present disclosure, a method for a network node for network slice management, includes: receiving a request regarding a network slice from a User Equipment, UE; and determining whether the network node for network slice management accepts the request based on information regarding use of resource of the network slice.

According to another aspect of the present disclosure, a method for a network node for network slice management, includes: receiving a request regarding a network slice; removing information corresponding to the request regarding the network slice; and updating information regarding use of resource of the network slice.

According to another aspect of the present disclosure, User Equipment, includes: means for transmitting a request regarding a network slice to a network node for mobility management; and means for receiving a response message for the request, including a cause indicating that a count regarding use of resource of the network slice has reached to a threshold, wherein the means for transmitting configured to not transmit another request regarding the network slice, based on the accept message.

According to another aspect of the present disclosure, A method for User Equipment, includes: transmitting a request regarding a network slice to a network node for mobility management; receiving a response message for the request, including a cause indicating that a count regarding use of resource of the network slice has reached to a threshold; and not transmitting another request regarding the network slice, based on the response message.

### Advantageous Effects of Invention

In certain aspects, a network node for network slice management, a method for a network node for network slice management, User Equipment, and a method for User Equipment may provide a technology for solving the problems as described above.

### BRIEF DESCRIPTION OF DRAWINGS

FIG. 1 is a schematic signalling (timing) diagram illustrating an exemplary method for controlling a maximum number of UEs per Network Slice by the SMN during registration.

FIG. 2 is a schematic signalling (timing) diagram illustrating an exemplary method for controlling a maximum number of UEs per Network Slice by SMN during deregistration.

FIG. 3 is a schematic signalling (timing) diagram illustrating an exemplary method for controlling a maximum number of UEs per Network Slice by the NSSF during registration.

FIG. 4 is a schematic signalling (timing) diagram illustrating an exemplary method for controlling a maximum number of UEs per Network Slice by the NSSF during deregistration.

FIG. 5 is a schematic signalling (timing) diagram illustrating an exemplary method for Network Slice parameters status enquiry by the NF.

FIG. 6 is a schematic signalling (timing) diagram illustrating an exemplary method for Network Slice parameters status notification by the SMN or NSSF.

FIG. 7 is a schematic signalling (timing) diagram illustrating an exemplary method for controlling a maximum number of PDU Sessions per Network Slice by the SMN/NSSF during PDU Session establishment.

FIG. 8 is a schematic signalling (timing) diagram illustrating an exemplary method for controlling a maximum number of PDU Sessions per Network Slice by the SMN/NSSF during PDU Session release.

FIG. 9 is a schematic signalling (timing) diagram illustrating an exemplary method for controlling a maximum number of PDU Sessions per Network Slice by the SMN/NSSF during Service Request procedure.

FIG. 10 is a schematic signalling (timing) diagram illustrating an exemplary method for controlling a maximum number of PDU Sessions per Network Slice by the SMN/NSSF during RAN connection release.

FIG. 11 is a schematic signalling (timing) diagram illustrating an exemplary method for controlling a maximum UL and DL data rate per UE in a Network Slice via the SMN/NSSF during a Service Request procedure.

FIG. 12 is a schematic signalling (timing) diagram illustrating an exemplary method for controlling a maximum UL and DL data rate per UE in a Network Slice via the SMN/NSSF during RAN connection release.

FIG. 13 schematically illustrates a mobile (cellular or wireless) telecommunication system.

FIG. 14 is a block diagram illustrating the main components of the UE (mobile device) shown in FIG. 13.

FIG. 15 is a block diagram illustrating the main components of an exemplary (R)AN node (base station) shown in FIG. 13.

FIG. 16 is a block diagram illustrating the main components of a generic core network node.

### DESCRIPTION OF EMBODIMENTS

### Detailed Description

Common embodiment—New Slice Management Node (SMN) 720

This embodiment proposes a new network node for Network Slice management call for example Slice Management Node (SMN) 720 or any other name or notation for the purpose of Network Slice management. The SMN 720 would provide the following functionality:

Maximum number of UEs per Network Slice monitoring and control. The SMN 720 would monitor and control the number of UEs registered for a specific Network Slice (i.e. S-NSSAI) and enforce any restrictions related to the max number of UEs per that Network Slice. In addition, the SMN 720 may manage Maximum number of UEs per network Slice across PLMNs. In this case, an operator who owns the SMN 720 establishes the NDA, Non-disclosure agreement, with a PLMN for use of Network Slice.

Maximum number of PDU Sessions per network Slice monitoring and control. The SMN 720 would monitor and control the number of PDU Sessions established per Network Slice and enforce any restrictions related to the max number of allowed PDU Sessions per Network Slice. In addition, the SMN 720 may manage Maximum number of PDU Sessions per network Slice per across PLMNs. In this case, the operator who owns the SMN 720 establishes the NDA, Non-disclosure agreement, with a PLMN for use of Network Slice.

Maximum UL and DL data rate per UE in a Network Slice monitoring and control. The SMN 720 would monitor and control the Uplink and Downlink data rate per UE in a specific Network Slice and enforce any restrictions related to the max UL data and/or max DL data per UE in a given Network Slice. In addition, the SMN 720 may manage an aggregated UL and DL data rate per network Slice across PLMNs. A Sum of all UL and DL data rate being used in that PLMN are monitored and controlled. In this case, the operator who owns the SMN 720 establishes the NDA, Non-disclosure agreement, with a PLMN for use of Network Slice.

Specific geographic areas configuration. The SMN 720 would configure a geographic area (e.g. cell, list of cells, TA, list of TAs) in which an authorized UE 3 is able to access the Network Slice and enforce them upon the UEs 3. The cell or the cell(s) in the list of cells can be identified by E-UTRAN Cell Identity (ECI) or E-UTRAN Cell Global Identification (ECGI) or NR Cell Identity (NCI) or NR Cell Global Identity (NCGI) or a set of them or a list of them. Alternatively, the geographic area can be identified by GPS data. Also, the geographic area can be data which is determined based on any parameter described above or data which is determined by combination of any parameters described above.

The newly defined SMN 720 may be a designated physical network node or a logical network node incorporated in one of the existing Network Nodes (e.g. NS SF 750, UDM 740, AMF 710 or NRF 730).

This embodiment proposes multiple solutions to implement the above described SMN functionality.

Solution 1—Max Number of UEs Per Network Slice Control

Aspect 1—Max Number of UEs Per Network Slice Control by SMN 720 During Registration

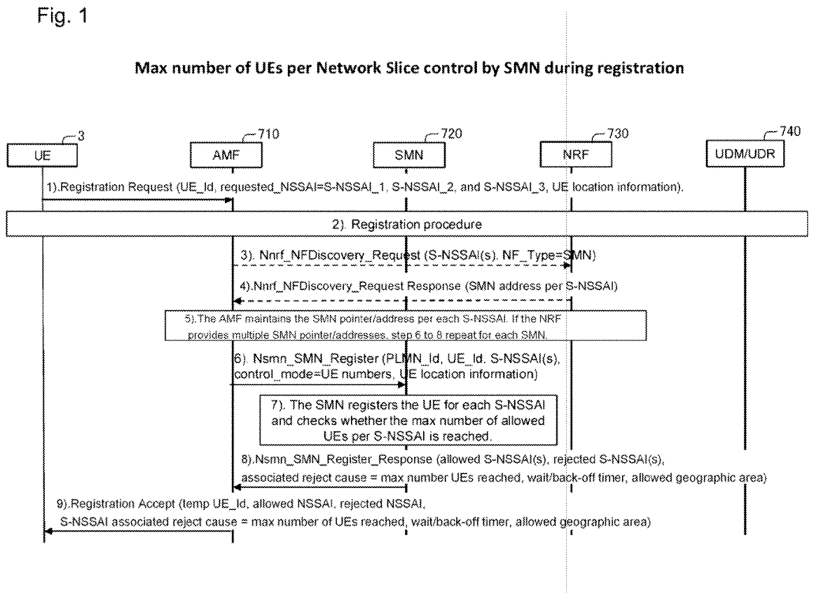

FIG. 1 is a schematic signalling (timing) diagram illustrating an exemplary method for controlling a maximum number of UEs per Network Slice by the SMN 720 during registration. In this example, the method includes the following steps:

1) The UE 3 initiates a registration procedure by triggering a Registration Request (UE_Id, requested NSSAI=S-NSSAI_1, S-NSSAI_2, and S-NSSAI_3, UE location information). In this registration example, the UE 3 requests registration for Network Slices S-NSSAI_1, S-NSSAI_2 and S-NSSAI_3. The UE 3 also includes in the Registration Request message a new parameter called UE location information or any other name or notation for parameter for the purpose of UE location information conveying to the AMF 710. The UE location information may be in the form of a cell Id or list of Cell Ids (e.g. E-UTRAN Cell Identity (ECI), E-UTRAN Cell Global Identification (ECGI), NR Cell Identity (NCI) or NR Cell Global Identity (NCGI) or a set of them or a list of them) or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon or IP address and port number for non-3GPP access or any other way of UE location identification. Alternatively, the UE location information can be identified by GPS data. Also, the UE location information can be data which is determined based on any parameter described above or data which is determined by combination of any parameters described above. If no UE location information is provided by the AMF 710, for example Release 15 compliant UE, then the AMF 710 uses the EUTRA-CGI, TAI, IP address and port number for the N3IWF or NR-CGI in the INITIAL UE MESSAGE from the RAN to the AMF 710 as defined in 3GPP TS 38.413 [6].

2) The Registration procedure continues before the AMF 710 is to send the Registration Accept message to the UE 3.

3) If the AMF 710 does not have the SMN address for S-NSSAI(s), the AMF 710 triggers an NRF enquiry to find the SMN address by triggering the Nnrf_NFDiscovery_Request (S-NSSAI(s), NF_Type=SMN) message to the NRF 730. The AMF 710 includes the list of the S-NSSAIs from the requested NSSAI from the UE 3 in the Registration Request message and also the NF_Type=SMN parameter in order to indicate to the NRF 730 that the enquiry is for the SMN address.

If the AMF 710 knows the SMN(s) address, steps 3 and 4 can be skipped. The AMF 710 may have local configurations for the SMN(s) address.

4) The NRF 730 obtains the SMN address which could be the same for all S-NSSAI(s) or it could be different one for each S-NSSAI and returns the SMN(s) address(es) in a Nnrf_NFDiscovery_Request Response (SMN address per S-NSSAI(s)) message.

5) The AMF 710 maintains the SMN pointer/address per each S-NSSAI. If the NRF 730 provides multiple SMN pointer/addresses in step 4, step 6 to 8 may repeat for each SMN 720.

6) The AMF 710 sends a Nsmn_SMN_Register (PLMN_Id, UE_Id, S-NSSAI(s), control_mode=UE numbers, UE location information) message in order to register the UE 3 for each S-NSSAI which the UE 3 requires registration with. The UE_Id can be IMSI, SUPI, GPSI, MSISDN or IPv4 address or IPv6 address or a combination of SUPI and user identifier(s) or a combination of GPSI and user identifier(s).

For this, the AMF 710 includes in the Nsmn_SMN_Register message the S-NSSAI(s) or list of S-NSSAI(s) that the UE 3 wants to register and the UE_Id itself. The UE 3 also passes to the SMN 720 the control_mode parameter set to ‘UE numbers’ value, meaning that the number of UEs per S-NSSAI are to be monitored and controlled plus the UE location information.

7) The SMN 720 checks for each S-NSSAI whether the number of the UEs has reached the max number of UEs per that S-NSSAI. The max number of UEs per S-NSSAI is either configure in the SMN 720 by the OAM or it is a threshold defined by the operator's policy or configuration. If the max number of the UEs per S-NSSAI is not reached, the SMN 720 adds the UE number in the list of UE registered for that S-NSSAI and increases the number of the UEs already registered for that S-NSSAI. In case of more than one S-NSSAIs, the process of the checks for max number of UEs per S-NSSAI and adding the UE_Id in the list of registered UEs per S-NSSAI is repeated for each S-NSSAI. The SMN 720 may manage UE location information and PLMN information together with registered UE 3.

If the max number of UEs per S-NSSAI is reached per certain S-NSSAI, the SMN 720 does not register the UE 3 for that S-NSSAI, i.e. does not add the UE 3 in the list of UEs registered with that S-NSSAI and does not increase the number of UEs registered with that S-NSSAI.

8) The SMN 720 answers with a Nsmn_SMN_Register_Response (allowed S-NSSAI(s), rejected S-NSSAI(s), associated reject cause=max number UEs reached, wait/back-off timer, allowed geographic area) message. If the max number of UEs for a certain Network Slice S-NSSAI is not reached, the SMN 720 returns the S-NSSAI(s) for which the max number of UEs is not reached within the allowed S-NSSAI(s) parameter. If the max number of UEs for a certain Network Slice S-NSSAI has been reached, the SMN 720 returns the S-NSSAI(s) for which the max number of UEs has been reached in the Rejected S-NSSAI(s) parameter. The SMN 720 may also return a reject cause ‘max number of UEs reached’ associated with each rejected S-NSSAI. In this case, the SMN 720 may also return a wait/back-off timer associated with the rejected S-NSSAI in order to prevent the UE 3 for coming back for the duration of the wait/back-off timer. The SMN 720 may also return a reject cause ‘max number of UEs reached per PLMN associated with each rejected S-NSSAI.

9) Registration Accept (temp UE_Id, allowed NSSAI, rejected NSSAI, S-NSSAI associated reject cause=max number of UEs reached, wait/back-off timer, allowed geographic area). The AMF 710 returns a Registration Accept message. The AMF 710 confirms in the allowed NSSAI the Network Slices S-NSSAI(s) that are allowed, i.e. the Network Slices the UE 3 has registered for successfully and also confirms the rejected Network Slices S-NSSAI(s) in the rejected NSSAI parameter.

For each rejected Network Slice S-NSSAI, the AMF 710 may include a reject cause in the 5-NSSAI associated reject cause parameter, e.g. ‘max number of UEs reached’ or any other name or notation for a parameter with the meaning that the maximum number of UE per that S-NSSAI has been reached. If the UE 3 is rejected from a Network Slice S-NSSAI with the reject cause=‘max number of UEs reached’ the UE 3 shall not attempt again to register for that S-NSSAI while the UE 3 is in that PLMN.

The AMF 710 may return a wait/back-off timer associated with the rejected Network Slice(es) 5-NSSAI(s). If the UE 3 is returned a wait timer or back-off timer associated with the rejected 5-NSSAI, the UE 3 starts the wait/back-off timer and the UE 3 shall not trigger another attempt to register for the rejected S-NSSAI(s) until the expiry of the wait/back-off timer.

A cell re-selection or re-registration by the UE 3 in the current registration area does not lift the restriction to register for the rejected S-NSSAI.

The AMF 710 may also return the ‘allowed geographic area’ parameter which may be in the form of a cell Id, list of cell Ids, TA, list of TAs or it can be represented in Ellipsoid Point, Ellipsoid Point with uncertainty Circle, Ellipsoid Point with uncertainty Ellipse, High Accuracy Ellipsoid point with uncertainty ellipse or Polygon. If the UE 3 is returned an ‘allowed geographic area’ associated with an allowed Network Slice S-NSSAI, the UE 3 shall not attempt to register for the associated Network Slice S-NSSAI while the UE 3 is out of the allowed geographic area. The cell or cell(s) in the list can be identified by E-UTRAN Cell Identity (ECI), E-UTRAN Cell Global Identification (ECGI), NR Cell Identity (NCI) or NR Cell Global Identity (NCGI) or a set of them or a list of them. Alternatively, the geographic area can be identified by GPS data. Also, the geographic area can be data which is determined based on any parameter described above or data which is determined by combination of any parameters described above.

In case that the Network Slice-Specific Authentication and Authorization procedure is supported, the step 3 to step 8 or step 6 to step 8 can be executed after the step 9.

Aspect 2—Max Number of UEs Per Network Slice Control by SMN 720 During Deregistration

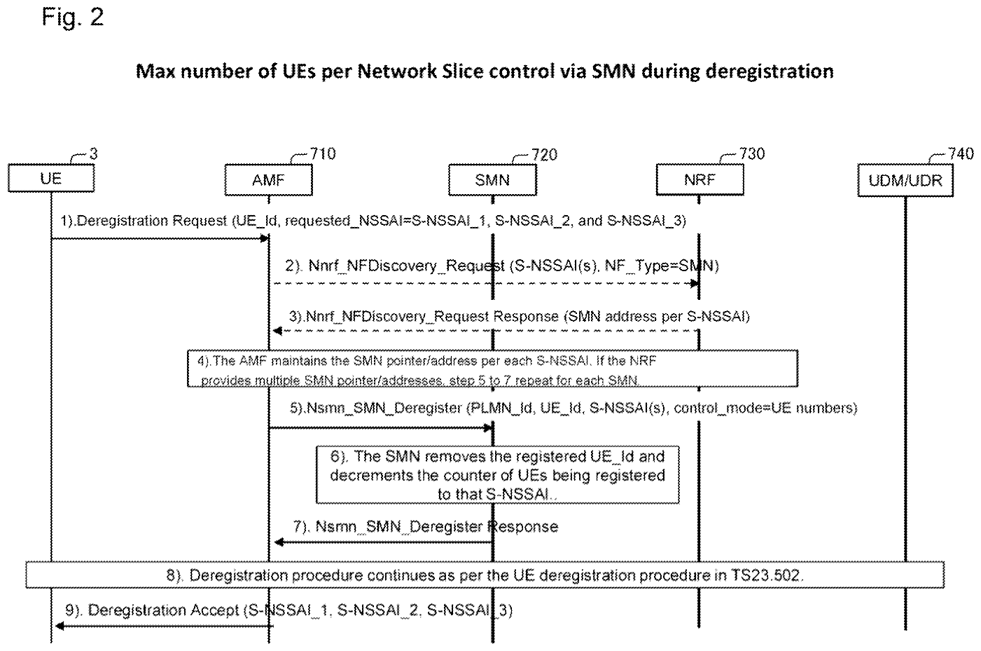

FIG. 2 is a schematic signalling (timing) diagram illustrating an exemplary method for controlling a maximum number of UEs per Network Slice by the SMN 720 during deregistration. In this example, the method includes the following steps:

1) The UE 3 initiates deregistration procedure by triggering a Deregistration Request (UE_Id, requested NSSAI=S-NSSAI_1, S-NSSAI_2, and S-NSSAI_3) message. In this deregistration example, the UE 3 requests deregistration for Network Slices S-NSSAI_1, S-NSSAI 2 and 5-NSSAI_3.

2) If the AMF 710 does not have the SMN address, the AMF 710 triggers a NRF enquiry to find the SMN address by triggering the Nnrf_NFDiscovery_Request (S-NSSAI(s), NF_Type=SMN) message to the NRF 730. The AMF 710 includes the list of the Network Slices S-NSSAIs from the requested NSSAI from the UE 3 in the Deregistration Request message and also the NF_Type=SMN parameter in order to indicate to the NRF 730 that the enquiry is for the SMN address.

If the AMF 710 knows the SMN(s) address, steps 2 and 3 are skipped.

3) The NRF 730 obtains the SMN address which could be the same for all the Network Slices S-NSSAI(s) or it could be different one for each S-NSSAI and the NRF 730 returns the SMN(s) address(es) in Nnrf_NFDiscovery_Request Response (SMN address per S-NSSAI) message.

4) The AMF 710 maintains the SMN pointer/address per each S-NSSAI. If the NRF 730 provides multiple SMN pointer/addresses in step 3, step 5 to 7 may repeat for each SMN 720.

5) The AMF 710 sends a Nsmn_SMN_Deregister (PLMN_Id, UE_Id, S-NSSAI(s), control_mode=UE numbers) message in order to deregister the UE 3 for each S-NSSAI which the UE 3 requires deregistration with. For this, the AMF 710 includes in the Nsmn_SMN_Deregister message the UE_Id and the S-NSSAI or list of S-NSSAI(s) that the UE 3 wants to deregister from. The UE 3 also passes to the SMN 720 the control_mode parameter set to ‘UE numbers’ value, meaning that the number of UEs per S-NSSAI are to be monitored and controlled.

The UE_Id can be IMSI, SUPI, GPSI, MSISDN or IPv4 address or IPv6 address or a combination of SUPI and user identifier(s) or a combination of GPSI and user identifier(s).

6) The SMN 720 removes the UE_Id from the list of UEs registered with the S-NSSAI for each S-NSSAI in the Nsmn_SMN_Deregister message and the SMN 720 decrements the counter of the UE numbers for each of these S-NSSAIs.

7) The SMN 720 answers with Nsmn_SMN_Deregister_Response message to confirm the removal of the UE_Id from the list of the UE numbers registered in the Network Slice for each of the Network Slice(s) S-NSSAI(s) passed to the SMN 720 in step 5.

8) Deregistration procedure continues as per the UE deregistration procedure in 3GPP TS 23.502 [3].

Note that step 8 can be executed before step 2.

9) Deregistration Accept (S-NSSAI_1, S-NSSAI_2, S-NSSAI_3) message. The AMF 710 confirms the UE deregistration from Network Slices S-NSSAI_1, S-NSSAI_2 and S-NSSAI_3. If there is/are wait or back-off timer(s) running in the UE 3 that are associated with the S-NSSAI(s) that the UE 3 has deregistered from, the UE 3 stops these wait/back-off timers.

Aspect 3—Max Number of UEs Per Network Slice Control by NSSF 750 During Registration

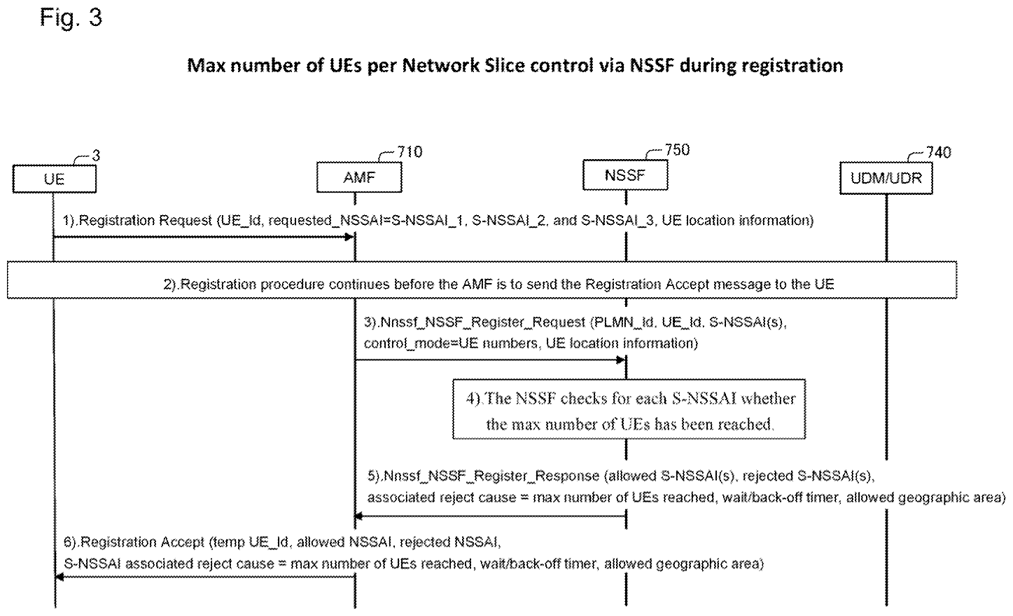

FIG. 3 is a schematic signalling (timing) diagram illustrating an exemplary method for controlling a maximum number of UEs per Network Slice by the NSSF 750 during registration. In this example, the method includes the following steps:

1) The UE 3 initiates registration procedure by triggering a Registration Request (UE_Id, requested NSSAI=S-NSSAI_1, S-NSSAI_2, and S-NSSAI_3, UE location information). In this registration example, the UE 3 requests registration for Network Slices S-NSSAI_1, S-NSSAI_2 and S-NSSAI_3. The UE 3 also includes in the Registration Request message a new parameter called UE location information or any other name or notation for parameter for the purpose of UE location information conveying to the AMF 710. The UE location information may be in the form of cell Id or list of Cell Ids (e.g. E-UTRAN Cell Identity (ECI), E-UTRAN Cell Global Identification (ECGI), NR Cell Identity (NCI), NR Cell Global Identity (NCGI) or a set of them or a list of them) or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon or IP address and port number for non-3GPP access or any other way of UE location identification. Alternatively, the UE location information can be identified by GPS data. Also, the UE location information can be data which is determined based on any parameter described above or data which is determined by combination of any parameters described above. If no UE location information is provided by the AMF 710, for example Release 15 compliant UE, then the AMF 710 uses the EUTRA-CGI, TAI, IP address and port number for the N3IWF or NR-CGI in the INITIAL UE MESSAGE from the RAN to the AMF 710 as defined in 3GPP TS 38.413 [6].

2) Registration procedure continues before the AMF 710 is to send the Registration Accept message to the UE 3.

3) The AMF 710 sends a Nnssf_NSSF_Register_Request (PLMN_Id, UE_Id, S-NSSAI(s), control_mode=UE numbers, UE location information) message in order to register the UE 3 for each S-NSSAI which the UE 3 requires registration with. The UE_Id can be IMSI, SUPI, GPSI, MSISDN or IPv4 address or IPv6 address or a combination of SUPI and user identifier(s) or a combination of GPSI and user identifier(s).

For this, the AMF 710 includes in the Nnssf_NSSF_Register_Request message the S-NSSAI or list of S-NSSAI that the UE 3 wants to register and the UE_Id itself. The UE 3 also passes to the SMN 720 the control_mode parameter set to ‘UE numbers’ value, meaning that the number of UEs per S-NSSAI are to be monitored and controlled plus the UE location information.

4) The NSSF 750 checks for each S-NSSAI whether the number of the UEs has reached the max number of UEs per that S-NSSAI. The max number of UEs per S-NSSAI is either configure in the NSSF 750 by the OAM or it is a threshold defined by the operator's policy or configuration. If the max number of the UE per S-NSSAI is not reached, the NSSF 750 adds the UE number in the list of UE registered for that S-NSSAI and increases the number of the UEs already registered for that S-NSSAI. In case of more than one S-NSSAIs, the process of the checks for max number of UEs per S-NSSAI and adding the UE_Id in the list of registered UEs per S-NSSAI is repeated for each S-NSSAI. The NSSF 750 may manage UE location information and PLMN information together with registered UE 3.

If the max number of UEs per S-NSSAI is reached per certain S-NSSAI, the NSSF 750 does not register the UE 3 for that S-NSSAI, i.e. does not add the UE 3 in the list of UEs registered with that S-NSSAI and does not increase the number of UEs registered with that S-NSSAI.

5) The NSSF 750 answers with the Nnssf_NSSF_Register_Response (allowed S-NSSAI(s), rejected S-NSSAI(s), associated reject cause=max number of UEs reached, wait/back-off timer, allowed geographic area) message. If the max number of UEs for a certain Network Slice S-NSSAI is not reached, the NSSF 750 returns the S-NSSAIs for which the max number of UEs is not reached within the allowed S-NSSAI(s) parameter. If the max number of UEs for a certain Network Slice S-NSSAI has been reached, the NSSF 750 returns the S-NSSAI(s) for which the max number of UEs has been reached in the rejected S-NSSAI(s) parameter. The NSSF 750 may also return a reject cause ‘max number of UEs reached’ associated with each rejected S-NSSAI. In this case, the NSSF 750 may also return a wait/back-off timer associated with the rejected S-NSSAI in order to prevent the UE 3 for coming back for the duration of the wait/back-off timer. The NSSF 750 may also return a reject cause ‘max number of UEs reached per PLMN’ associated with each rejected S-NSSAI.

6) Registration Accept (temp UE_Id, allowed NSSAI, rejected NSSAI, S-NSSAI associated reject cause=max number of UEs reached, wait/back-off timer, allowed geographic area). The AMF 710 returns a Registration Accept message. The AMF 710 confirms in the allowed NSSAI the Network Slices S-NSSAI(s) that are allowed, i.e. the Network Slices the UE 3 has registered for successfully and also confirms the rejected Network Slices S-NSSAI(s) in the rejected NSSAI parameter.

For each rejected Network Slice S-NSSAI, the AMF 710 may include a reject cause in the S-NSSAI associated reject cause parameter, e.g. ‘max number of UEs reached’ or any other name or notation for a parameter with the meaning that the maximum number of UE per that S-NSSAI has been reached. If the UE 3 is rejected from a Network Slice S-NSSAI with the reject cause=‘max number of UEs reached’, the UE 3 shall not attempt again to register for that S-NSSAI while the UE 3 is in that PLMN.

The AMF 710 may return a wait/back-off timer associated with the rejected Network Slice(es) 5-NSSAI(s). If UE 3 is returned a wait timer or back-off timer associated with the rejected S-NSSAI, the UE 3 starts the wait/back-off timer and the UE 3 shall not trigger another attempt to register for the rejected S-NSSAI(s) until the expiry of the wait/back-off timer.

A cell re-selection or re-registration by the UE 3 in the current registration area does not lift the restriction to register for the rejected S-NSSAI.

The AMF 710 may also return the ‘allowed geographic area’ parameter which may be in a form of a cell Id, list of cell Ids, TA, list of TAs or it can be represented in Ellipsoid Point, Ellipsoid Point with uncertainty Circle, Ellipsoid Point with uncertainty Ellipse, High Accuracy Ellipsoid point with uncertainty ellipse or Polygon. If the UE 3 is returned an ‘allowed geographic area’ associated with an allowed Network Slice S-NSSAI, the UE 3 shall not attempt to register for the associated Network Slice S-NSSAI while the UE 3 is out of the allowed geographic area. The cell or the cell(s) in the list can be identified by E-UTRAN Cell Identity (ECI), E-UTRAN Cell Global Identification (ECGI), NR Cell Identity (NCI) or NR Cell Global Identity (NCGI) or a set of them or a list of them. Alternatively, the geographic area can be identified by GPS data. Also, the geographic area can be data which is determined based on any parameter described above or data which is determined by combination of any parameters described above.

In case that the Network Slice-Specific Authentication and Authorization procedure is supported, the step 3 to step 5 can be executed after the step 6.

Aspect 4—Max Number of UEs Per Network Slice Control by NSSF 750 During Deregistration

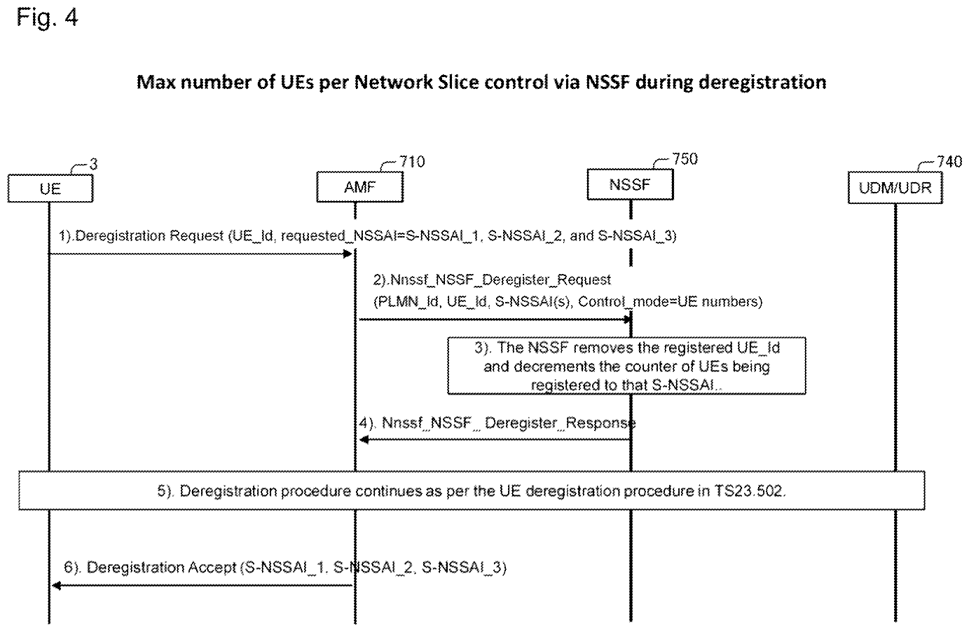

FIG. 4 is a schematic signalling (timing) diagram illustrating an exemplary method for controlling a max number of UEs per Network Slice by the NSSF 750 during deregistration. In this example, the method includes the following steps:

1) The UE 3 initiates deregistration procedure by triggering a Deregistration Request (UE_Id, requested NSSAI=S-NSSAI_1, S-NSSAI_2, and S-NSSAI_3) message. In this deregistration example, the UE 3 requests deregistration for Network Slices S-NSSAI_1, S-NSSAI 2 and 5-NSSAI_3.

2) The AMF 710 sends a Nnssf_NSSF_Deregister_Request (PLMN_Id, UE_Id, S-NSSAI(s), Control_mode=UE numbers) message in order to deregister the UE 3 for each S-NSSAI which the UE 3 requires deregistration with. For this, the AMF 710 includes in the Nnssf_NSSF_Deregister_Request message the UE_Id and the S-NSSAI or list of S-NSSAI(s) that the UE 3 wants to deregister from. The UE 3 also passes to the NSSF 750 the control_mode parameter set to ‘UE numbers’ value, meaning that the number of UEs per S-NSSAI is to be monitored and controlled.

The UE_Id can be IMSI, SUPI, GPSI, MSISDN or IPv4 address or IPv6 address or a combination of SUPI and user identifier(s) or a combination of GPSI and user identifier(s).

3) The NSSF 750 removes the UE_Id from the list of UEs registered with the S-NSSAI for each S-NSSAI in the Nnssf_NSSF_Deregister_Request message and the SMN 720 decrements the counter of the UE numbers for each of these S-NSSAIs.

4) The NSSF 750 answers with the Nnssf_NSSF_Deregister_Response message to confirm the removal of the UE_Id from the list of the UE numbers registered in the Network Slice for each of the Network Slices S-NSSAIs passed to the SMN 720 in step 5.

5) Deregistration procedure continues as per the UE deregistration procedure in 3GPP TS 23.502 [3].

Note that step 5 can be executed before step 2.

6) Deregistration Accept (S-NSSAI_1, S-NSSAI_2, S-NSSAI_3) message. The AMF 710 confirms the UE deregistration from Network Slices S-NSSAI_1, S-NSSAI_2 and S-NSSAI_3. If there is/are wait or back-off timer(s) running in the UE 3 that are associated with the S-NSSAI(s) that the UE 3 has deregistered from, the UE 3 stops these wait/back-off timers.

Aspect 5—Network Slice Parameters Status Enquiry by NF 760

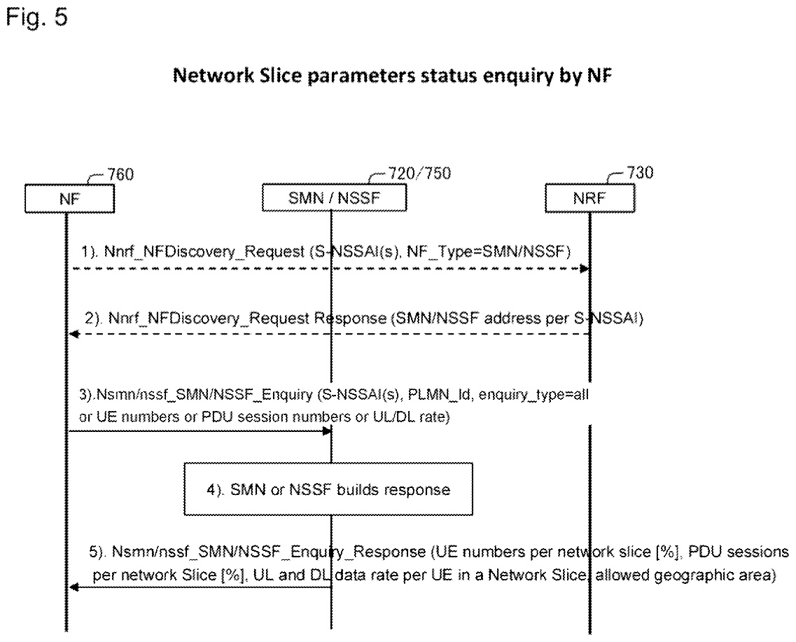

FIG. 5 is a schematic signalling (timing) diagram illustrating an exemplary method for Network Slice parameters status enquiry by the NF 760. In this example, the method includes the following steps:

1) Nnrf_NFDiscovery_Request (S-NSSAI(s), NF_Type=SMN/NSSF)—A NF (Network Function) 760 may decide at any time to find out the status of certain Network Slice e.g. whether:

the max number of UEs for that Network Slice S-NSSAI has been reached or not or just the number of UEs that have already been registered with that Network Slice S-NSSAI in term of numbers or percentages; OR

the max number of PDU Sessions for that Network Slice S-NSSAI has been reached or not or just the number of already registered PDU Sessions with the Network Slice S-NSSAI in terms of numbers or percentage; OR

the max of UL data rate or DL data rate or both per UE in the Network Slice S-NSSAI has been reached or not; OR

combination of two or more of the above Parameters status at the same time.

If the NF 760 has not got the address of the SMN 720 or NSSF 750 which can provide the information about the Network Slice's parameters and limitations, the NF 760 first initiates the SMN 720 or NSSF 750 discovery by sending a Nnrf_NFDiscovery_Request (S-NSSAI(s), NF_Type=SMN) to the NRF 730 for the case of SMN discovery or Nnrf_NFDiscovery_Request (S-NSSAI(s), NF_Type=NSSF) to the NRF 730 for the case of NSSF discovery. The NF 760 includes as a parameter the Network Slice or Network Slices which the enquiry is about and as another parameter the “SMN” or “NSSF” in order to find the address of the responsible SMN 720 or NSSF 750.

If the NF 760 has the SMN or NSSF address, step 2 and 3 are skipped. The AMF 710 may have local configurations for the SMN(s) address.

2) Nnrf_NFDiscovery_Request Response (SMN/NSSF address per S-NSSAI)—The NRF 730 returns the address or pointer to the SMN 720 or NSSF 750 that holds usage information for the enquired Network Slice(es) S-NSSAI(s).

3) Nsmn/nssf_SMN/NSSF_Enquiry (S-NSSAI(s), PLMN_Id, enquiry_type=all or UE numbers or PDU session numbers or UL/DL rate)—The NF 760 send a Nsmn_SMN_Enquiry (S-NSSAI(s), PLMN_Id, enquiry_type=all or UE numbers or PDU session numbers or UL/DL rate) to the SMN 720 or Nnssf_NSSF_Enquiry (S-NSSAI(s), PLMN_Id, enquiry_type=all or UE numbers or PDU session numbers or UL/DL rate) to the NSSF 750. The NF 760 includes as a parameter one or more Network Slice(es)S-NSSAI and another parameter to indicate the type of the required information, see details in step 1.

The NF 760 also includes the PLMN_Id to the Nsmn/nssf_SMN/NSSF_Enquiry message.

4) SMN 720 or NSSF 750 builds response—The SMN 720 or NSSF 750 collects the requested information per Network Slice.

If the NF 760 includes the PLMN_Id to the Nsmn/nssf_SMN/NSSF_Enquiry message in step 3, then the SMN 720 or NSSF 750 builds up the other requested information per Network Slice that are only related to that PLMN in addition to the requested information per Network Slice.

5) Nsmn/nssf_SMN/NSSF_Enquiry_Response (UE numbers per network slice [%], PDU sessions per network Slice [%], UL and DL data rate per UE in a Network Slice, allowed geographic area)—The SMN 720 or NSSF 750 returns the status information per Network Slice 5-NSSAI via the Nsmn_SMN_Enquiry_Response or Nnssf_NSSF_Enquiry_Response in a format required by the NF 760. The SMN 720 or NSSF 750 may also return the status information per Network Slice S-NSSAI that are only related to that PLMN via the Nsmn_SMN_Enquiry_Response or Nnssf_NSSF_Enquiry_Response in a format required by the NF 760.

UE numbers per network slice can be expressed by percentage or composed of current number of UEs and maximum number of UEs.

PDU Sessions per network Slice can be expressed by percentage or composed of current number of PDU sessions per network Slice and maximum number of PDU sessions per network Slice

Aspect 6—Network Slice Parameters Status Notification by SMN 720 or NSSF 750

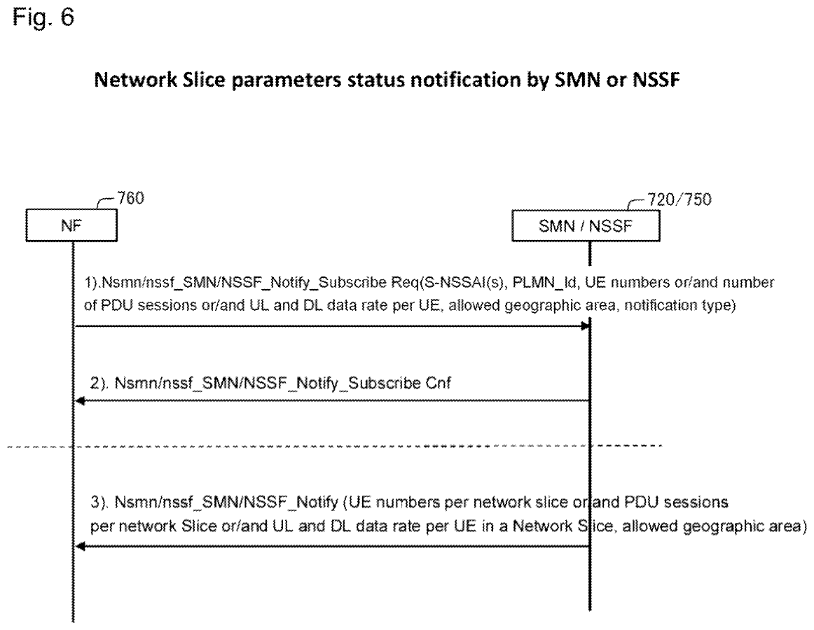

FIG. 6 is a schematic signalling (timing) diagram illustrating an exemplary method for Network Slice parameters status notification by the SMN 720 or NSSF 750. In this example, the method includes the following steps:

1) Nsmn/nssf_SMN/NSSF_Notify_Subscribe Req(S-NSSAI(s), PLMN_Id, UE numbers or/and number of PDU sessions or/and UL and DL data rate per UE, allowed geographic area, notification type)—An NF (Network Function) 760 can subscribe with the SMN 720 or NSSF 750 for notification of one or more parameters for one or more Network Slices. The NF 760 includes the following parameters:

S-NSSAI(s)—one or more Network Slices S-NSSAI(s) for which parameters notification is required;

PLMN_Id—The NF 760 can request to receive a notification that are only related to the PLMN;

parameters to be notified. The subscription could be for one or more of the following Network Slice parameters:

+max number of UEs for that Network Slice S-NSSAI e.g. whether the max number of UEs for certain S-NSSAI has been reached or not or just the number of UEs that have already been registered with that Network Slice S-NSSAI in term of numbers or percentages; OR/AND

+number of PDU Sessions for that Network Slice e.g. whether the max number of PDU session per S-NSSAI has been reached or not or just the number of already registered PDU Sessions with the Network Slice S-NSSAI in terms of numbers or percentage; OR/AND

+UL or DL data rate or both per UE in the Network Slice e.g. whether the max UL and/or DL data rate for a UE 3 in a S-NSSAI has been reached or not or just the current UL or DL data rate or both; OR

+a combination of two or more of the above parameters status at the same time.

notification type—the notification subscription can be for periodic notification or event based notification e.g. when a configured threshold ids has reached or when the max allowed value has been reached.

2) Nsmn/nssf_SMN/NSSF_Notify_Subscribe Cnf—The SMN 720 or the NSSF 750 confirms the notification subscription back to the NF 760.

3) Nsmn/nssf_SMN/NSSF_Notify (UE numbers per network slice or/and PDU sessions per network Slice or/and UL and DL data rate per UE in a Network Slice, allowed geographic area)—The SMN 720 or NSSF 750 reports the status of the Network Slice parameters that the NF 760 is subscribed to periodically or on event triggered bases. The NF 760 may use the information about the status of the network parameters to control the usage of the Network Slice in terms of control the numbers of UEs registered for certain Network Slice, or control the number of the PDU Sessions established with a Network Slice or control the UL and or DL data rate per UE in a Network Slice. For example the NF 760 may adjust the required QoS, may restrict the number of UEs or PDU Sessions in a Network Slice and achieve a congestion control and in a Network Slice and load balancing between the Network Slices.

If the NF 760 includes the PLMN_Id to the Nsmn/nssf_SMN/NSSF_Notify_Subscribe Request message in step 1, then the SMN 720 or NSSF 750 reports the other status of the Network Slice parameters that are only related to that PLMN in addition to the status of the Network Slice parameters that the NF 760 is subscribed to.

Solution 2—Max Number of UEs Per Network Slice Control

Aspect 1—Max Number of PDU Sessions Per Network Slice Control by SMN 720/NSSF 750 During PDU Session Establishment.

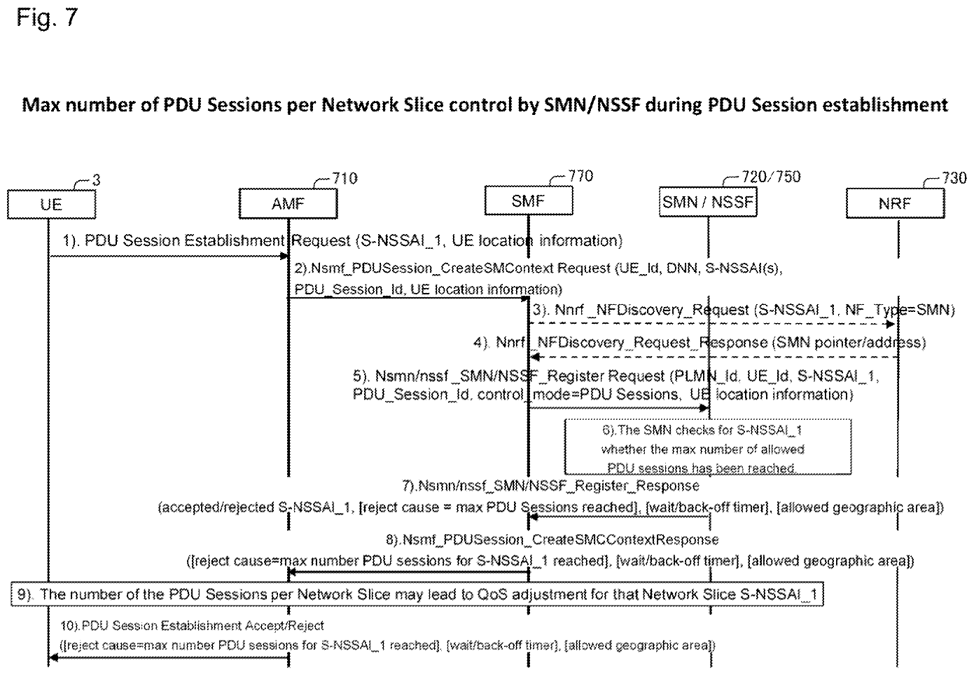

FIG. 7 is a schematic signalling (timing) diagram illustrating an exemplary method for controlling a maximum number of PDU Sessions per Network Slice by the SMN 720/NSSF 750 during PDU Session establishment. In this example, the method includes the following steps:

1) PDU Session Establishment Request (S-NSSAI_1, UE location information)—The UE 3 initiates PDU Session Establishment procedure. The UE 3 includes the UE_Id, the DNN, the 5-NSSAI or list of S-NSSAIs, the PDU_Session_Id and the UE location information. UE location information is needed to check whether the UE 3 is allowed to initiate PDU Session establishment from its current location. The UE location information may be in the form of cell Id or list of Cell Ids (e.g. E-UTRAN Cell Identity (ECI), E-UTRAN Cell Global Identification (ECGI), NR Cell Identity (NCI) or NR Cell Global Identity (NCGI) or a set of them or a list of them) or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon or IP address and port number for non-3GPP access or any other way of UE location identification. Alternatively, the UE location information can be identified by GPS data. Also, the UE location information can be data which is determined based on any parameter described above or data which is determined by combination of any parameters described above. If no UE location information is provided by the AMF 710, for example Release 15 compliant UE, then the AMF 710 uses the EUTRA-CGI, TAI, IP address and port number for the N3IWF or NR-CGI in the INITIAL UE MESSAGE from the RAN to the AMF 710 as defined in 3GPP TS 38.413 [6]. The UE_Id can be IMSI, SUPI, GPSI, MSISDN or IPv4 address or IPv6 address or a combination of SUPI and user identifier(s) or a combination of GPSI and user identifier(s).

2) Nsmf_PDUSession_CreateSMContext Request (UE_Id, DNN, S-NSSAI(s), PDU_Session_Id, UE location information).—The AMF 710 forwards the PDU Session establishment request to the selected SMF 770.

3) Nnrf_NFDiscovery_Request (S-NSSAI_1, NF_Type=SMN) If the AMF 710 does not have the SMN address, the AMF 710 triggers a NRF enquiry to find the SMN address. The AMF 710 includes the list of the Network Slice S-NSSAI_1 and also the NF_Type=SMN parameter in order to indicate to the NRF 730 that the enquiry is for the SMN address.

If the AMF 710 knows the SMN(s) address, steps 3 and 4 are skipped.

4) Nnrf_NFDiscovery_Request Response (SMN pointer/address)—The NRF 730 obtains the SMN address that holds the information for S-NSSAI_1 and the NRF 730 returns the SMN address in a Nnrf_NFDiscovery_Request Response (SMN address per S-NSSAI_1) message

5) The SMF 770 sends a Nsmn/nssf_SMN/NSSF_Register Request (PLMN_Id, UE_Id, 5-NSSAI_1, PDU_Session_Id, control_mode=PDU Sessions, UE location information) message in order to register the PDU_Session_Id for S-NSSAI_1.

6) The SMN 720 checks for S-NSSAI_1 whether the max number of allowed PDU sessions has been reached. If the maximum number of PDU Sessions per S-NSSAI_1 is not reached, the SMN 720 increases the number of PDU Sessions in S-NSSAI_1. The max number of PDU Sessions per S-NSSAI is either configured in the SMN 720 by the OAM or it is a threshold defined by the operator's policy or configuration.

If the max number of PDU Sessions per S-NSSAI_1 has been reached, the SMN 720 does not register the PDU_Session_Id for S-NSSAI_1, i.e. does not add the PDU_Session_Id in the list of PDU Sessions with S-NSSAI_1 and does not increase the number of PDU Sessions registered with S-NSSAI_1

7) Nsmn/nssf_SMN/NSSF_Register_Response(accepted/rejected S-NSSAI_1, [reject cause=max PDU Sessions reached], [wait/back-off timer], [allowed geographic area])

If the maximum number of PDU sessions in S-NSSAI_1 is not reached, the SMN 720/NSSF 750 returns the S-NSSAI_1 as accepted Network Slice and may also return a geographic area within the allowed geographic area parameter. The allowed geographic area parameter allows the UE 3 to trigger PDU Session establishment for S-NSSAI_1 only in the allowed geographic area. The allowed geographic area may be in the form of cell Id or list of cell Ids or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon. The cell or the cell(s) in the list can be identified by E-UTRAN Cell Identity (ECI), E-UTRAN Cell Global Identification (ECGI), NR Cell Identity (NCI) or NR Cell Global Identity (NCGI) or a set of them or a list of them. Alternatively, the geographic area can be identified by GPS data. Also, the geographic area can be data which is determined based on any parameter described above or data which is determined by combination of any parameters described above.

If the maximum number of PDU sessions in S-NSSAI_1 has been reached, the SMN 720/NSSF 750 returns a reject cause=max PDU Sessions reached and the SMN 720 may also return a wait timer or back-off timer.

8) Nsmf_PDUSession_CreateSMCContextResponse ([reject cause=max number PDU sessions for S-NSSAI_1 reached], [wait/back-off timer], [allowed geographic area]).

9) The number of the PDU Sessions per Network Slice may lead to QoS adjustment for Network Slice S-NSSAI_1.

10) PDU Session Establishment Accept/Reject ([reject cause=max number PDU sessions for 5-NSSAI_1 reached], [wait/back-off timer], [allowed geographic area]).

If the maximum PDU Sessions for S-NSSAI_1 is not reached, the PDU Session establishment is accepted. If so, the UE 3 may receive allowed geographic area for S-NSSAI_1 from the SMF 770 via the AMF 710 meaning the UE 3 can trigger a PDU Session establishment for S-NSSAI_1 only in the returned allowed geographic area. The allowed geographic area may be in the form of cell Id or list of cell Ids or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon.

If the maximum PDU Sessions for S-NSSAI_1 has been reached, the PDU Session establishment is rejected. In this case the UE 3 receives a reject cause=max number PDU Sessions reached from the SMF 770 via the AMF 710. The UE 3 may receive from the SMF 770 via the AMF 710 a wait/back-off timer as well in which case the UE 3 shall not attempt another PDU Session establishment for S-NSSAI_1 while the wait/back-off timer is running.

One example, step 2 to step 8 can be executed after the step 9.

Aspect 2—Max number of PDU Sessions per Network Slice control by SMN 720/NSSF 750 during PDU Session release

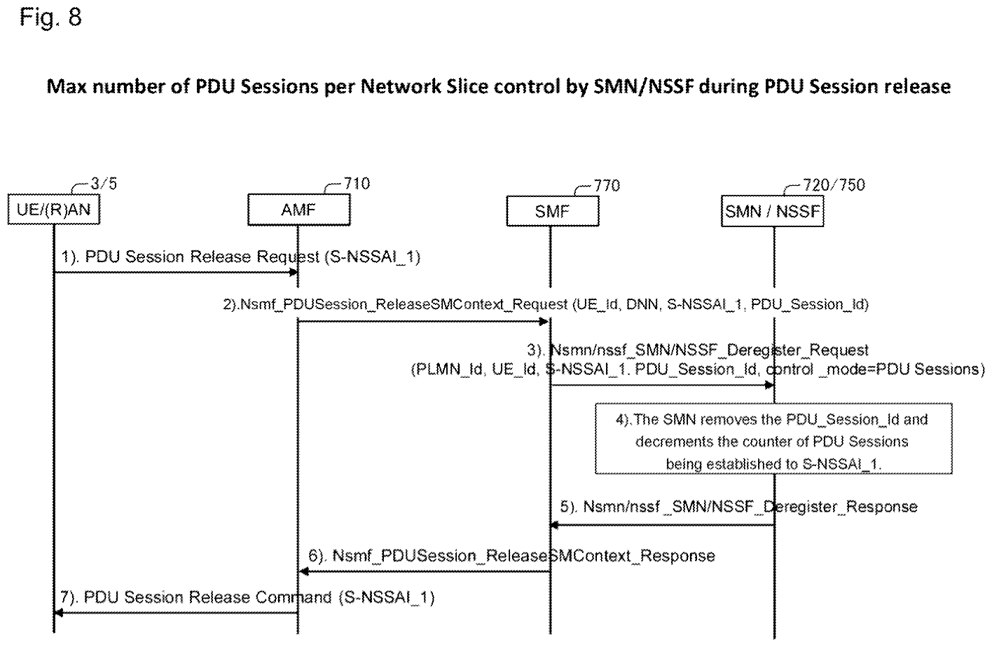

FIG. 8 is a schematic signalling (timing) diagram illustrating an exemplary method for controlling a maximum number of PDU Sessions per Network Slice by the SMN 720/NSSF 750 during PDU Session release. In this example, the method includes the following steps:

1) PDU Session Release Request (S-NSSAI_1)—The UE or RAN node trigger release of PDU Session on Network Slice S-NSSAI_1.

2) Nsmf_PDUSession_ReleaseSMContext_Request (UE_Id, DNN, S-NSSAI_1, PDU_Session_Id)—The AMF 710 requests the SMF 770 to release the SM session. The UE 3 include in the release message the UE_Id, DNN, the Network Slice S-NSSAI_1 and the PDU_Session_Id to be released.

3) Nsmn/nssf_SMN/NSSF_Deregister_Request (PLMN_Id, UE_Id, S-NSSAI_1, PDU_Session_Id,control_mode=PDU Sessions)—The SMF 770 request deregistration of the PDU_Session_Id from the list of PDU Sessions established in Network Slice S-NSSAI_1. The SMF 770 includes the PDU_Session_Id and the control_mode parameter set to ‘PDU Sessions’, i.e. the number of PDU Sessions for S-NSSAI_1 is to be controlled (decreased in this case).

4) The SMN 720 removes the registered PDU_Session_Id from the list of PDU Session with S-NSSAI_1 and decrements the counter of PDU Sessions being established to S-NSSAI_1.

5) Nsmn/nssf_SMN/NSSF_Deregister_Response—The SMN 720/NSSF 750 responds to the SMF 770 after successful operation.

6) Nsmf_PDUSession_ReleaseSMContext_Response—The SMF 770 confirms the PDU Session release to the AMF 710

7) PDU Session Release Command (S-NSSAI_1)—the AMF 710 confirms the PDU Session release to the UE 3 or RAN Node 5.

One example, step 3 to step 5 can be executed after step 6.

Aspect 3—Max Number of PDU Sessions Per Network Slice Control by SMN 720/NSSF 750 During Service Request Procedure

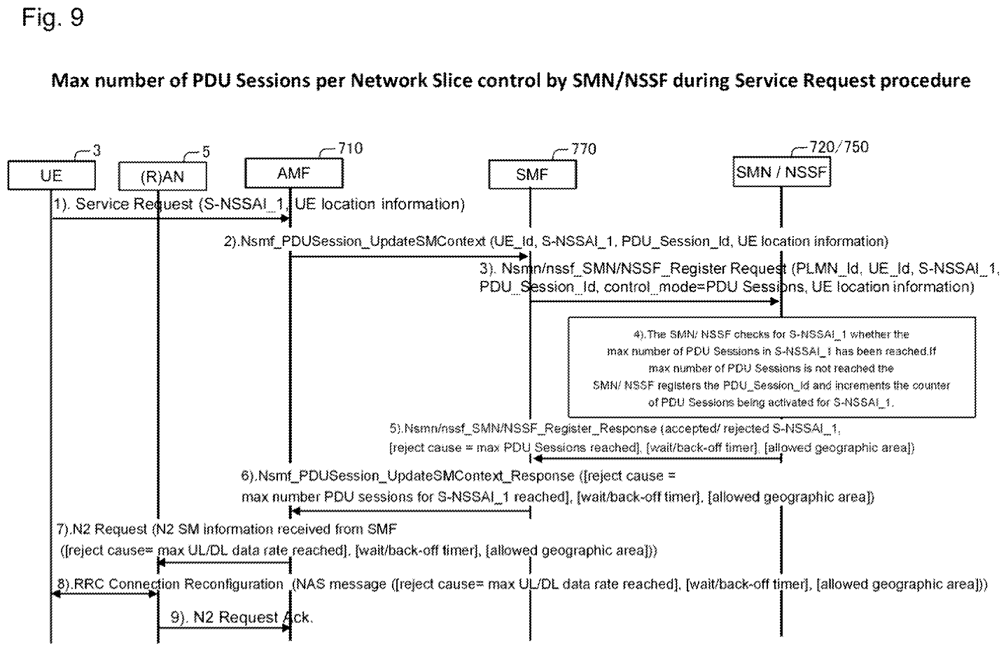

FIG. 9 is a schematic signalling (timing) diagram illustrating an exemplary method for controlling a maximum number of PDU Sessions per Network Slice by the SMN 720/NSSF 750 during Service Request procedure. In this example, the method includes the following steps:

1) Service Request (S-NSSAI_1, UE location information)—UE 3 triggers a Service Request for Network Slice S-NSSAI_1. The UE 3 may include its location information in the UE location information parameter. UE location information is needed to check whether the UE 3 is allowed to initiate PDU Session establishment from its current location. The UE location information may be in the form of cell Id or list of Cell Ids (e.g. E-UTRAN Cell Identity (ECI), E-UTRAN Cell Global Identification (ECGI), NR Cell Identity (NCI) or NR Cell Global Identity (NCGI) or a set of them or a list of them) or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon or IP address and port number for non-3GPP access or any other way of UE location identification. Alternatively, the UE location information can be GPS data. Also, the UE location information can be data which is determined based on any parameter described above or data which is determined by combination of any parameters described above. If no UE location information is provided by the AMF 710, for example Release 15 compliant UE, then the AMF 710 uses the EUTRA-CGI, TAI, IP address and port number for the N3IWF or NR-CGI in the INITIAL UE MESSAGE from the RAN to the AMF 710 as defined in 3GPP TS 38.413 [6].

2) Nsmf_PDUSession_UpdateSMContext (UE_Id, S-NSSAI_1, PDU_Session_Id, UE location information)—The AMF 710 selects a SMF 770 and requests SM context establishment. The UE_Id can be IMSI, SUPI, GPSI, MSISDN or IPv4 address or IPv6 address or a combination of SUPI and user identifier(s) or a combination of GPSI and user identifier(s).

3) The SMF 770 sends a Nsmn/nssf_SMN/NSSF_Register_Request (PLMN_Id, UE_Id, 5-NSSAI_1, PDU_Session_Id, control_mode=PDU Sessions, UE location information) in order to register the PDU_Session_Id for S-NSSAI_1. The SMF 770 sets the control_mode parameter to PDU Sessions to indicate that the request is for control of PDU Session numbers in S-NSSAI_1.

4) The SMN 720/NSSF 750 checks for S-NSSAI_1 whether the max number of PDU Sessions in S-NSSAI_1 has been reached. If max number of PDU Sessions is not reached, the SMN 720/NSSF 750 registers the PDU_Session_Id and increments the counter of PDU Sessions being activated for S-NSSAI_1.

5) The SMN 720/NSSF 750 sends a Nsmn/nssf_SMN/NSSF_Register_Response (accepted/rejected S-NSSAI_1, [reject cause=max PDU Sessions reached], [wait/back-off timer], [allowed geographic area]) message to the SMF 770.

6) The SMF 770 sends a Nsmf_PDUSession_UpdateSMContext Response ([reject cause=max number PDU sessions for S-NSSAI_1 reached], [wait/back-off timer], [allowed geographic area]) message to the AMF 710.

If the maximum number of PDU sessions in S-NSSAI_1 is not reached, the SMN 720/NSSF 750 returns the S-NSSAI_1 as accepted Network Slice and may also return a geographic area within the allowed geographic area parameter. The allowed geographic area parameter allows the UE 3 to trigger PDU Session establishment for S-NSSAI_1 only in the allowed geographic area. The allowed geographic area may be in the form of cell Id or list of cell Ids or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon. The cell or the cell(s) in the list can be identified by E-UTRAN Cell Identity (ECI) or E-UTRAN Cell Global Identification (ECGI) or NR Cell Identity (NCI) or NR Cell Global Identity (NCGI) or a set of them or a list of them. Alternatively, the geographic area can be identified by GPS data. Also, the geographic area can be data which is determined based on any parameter described above or data which is determined by combination of any parameters described above.

If the maximum number of PDU sessions in S-NSSAI_1 has been reached, the SMN 720/NSSF 750 returns a reject cause=max PDU Sessions reached and the SMN 720 may also return a wait timer or back-off timer.

7) The AMF 710 sends N2 Request (N2 SM information received from SMF 770 ([reject cause=max UL/DL data rate reached], [wait/back-off timer], [allowed geographic area])) message to the RAN.

8) The NG-RAN performs RRC Connection Reconfiguration with the UE 3. The RRC reconfiguration message from the RAN to UE 3 includes the NAS message (N2 SM information received from SMF 770 ([reject cause=max UL/DL data rate reached], [wait/back-off timer], [allowed geographic area])).

If the maximum PDU Sessions for S-NSSAI_1 is not reached, the Service Request is accepted. If so, the UE 3 may receive allowed geographic area for S-NSSAI_1 from the SMF 770 via the AMF 710 meaning the UE 3 can trigger a Service Request for S-NSSAI_1 only in the returned allowed geographic area. The allowed geographic area may be in the form of cell Id or list of cell Ids or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon. The cell Ids/list of cell Ids can be E-UTRAN Cell Identity (ECI) or E-UTRAN Cell Global Identification (ECGD or NR Cell Identity (NCI) or NR Cell Global Identity (NCGI) or a set of them or a list of them. Alternatively, the geographic area can be GPS data. Also, the geographic area can be data which is determined based on any parameter described above or data which is determined by combination of any parameters described above.

If the maximum PDU Sessions for S-NSSAI_1 has been reached, the Service Request is rejected. In this case the UE 3 receives a reject cause=max number PDU Sessions reached from the SMF 770 via the AMF 710. The UE 3 may receive a wait/back-off timer as well from the SMF 770 via the AMF 710 in which case the UE 3 shall not attempt another PDU Session establishment for 5-NSSAI_1 while the wait/back-off timer is running.

9) The (R)AN node 5 sends N2 Request Ack (List of PDU Sessions To Be Established with N2 SM information (AN Tunnel Info, List of accepted QoS Flows for the PDU Sessions whose UP connections are activated, List of rejected QoS Flows for the PDU Sessions whose UP connections are activated), List of PDU Sessions that failed to be established with the failure cause given in the N2 SM information element) to the AMF 710.

Aspect 4—Max Number of PDU Sessions Per Network Slice Control by SMN 720/NSSF 750 During RAN Connection Release

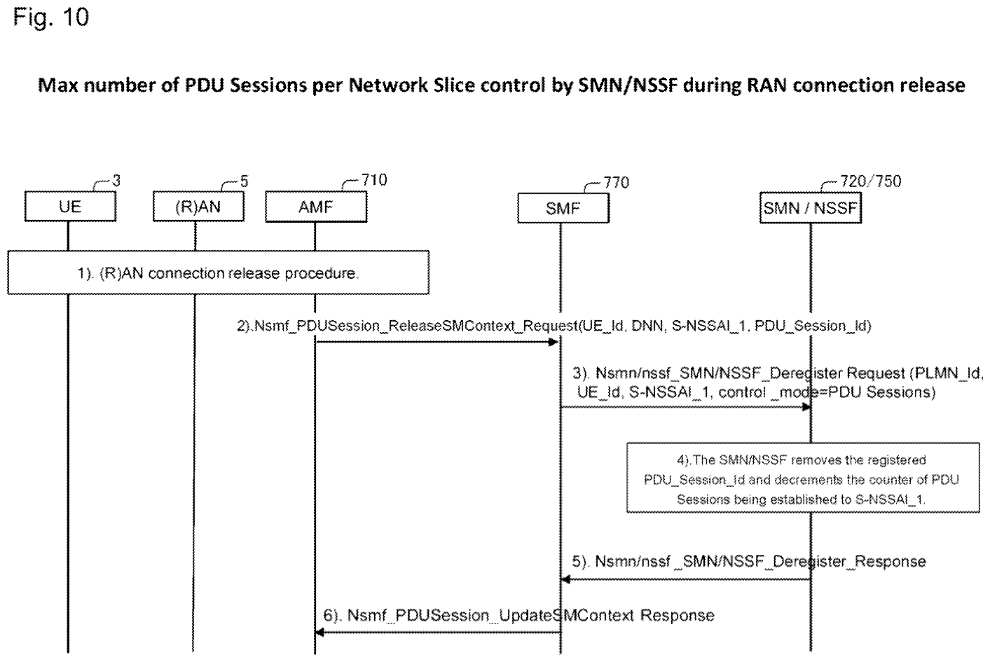

FIG. 10 is a schematic signalling (timing) diagram illustrating an exemplary method for controlling a maximum number of PDU Sessions per Network Slice by the SMN 720/NSSF 750 during RAN connection release. In this example, the method includes the following steps:

1) (R)AN connection release procedure.

2) Nsmf_PDUSession_ReleaseSMContext_Request(UE_Id, DNN, S-NSSAI_1, PDU_Session_Id)—The AMF 710 requests the SMF 770 to release the SM session an include in the release message the UE_Id, DNN, the Network Slice S-NSSAI_1 and the PDU_Session_Id to be released.

3) Nsmn/nssf_SMN/NSSF_Deregister_Request (PLMN_Id, UE_Id, S-NSSAI_1, control mode=PDU Sessions)—The SMF 770 request deregistration of the PDU_Session_Id from the list of PDU Sessions established in Network Slice S-NSSAI_1. The SMF 770 include the PDU_Session_Id and the control_mode parameter set to ‘PDU Sessions’, i.e. the number of PDU Sessions for S-NSSAI_1 is to be controlled (decreased in this case).

4) The SMN 720/NSSF 750 removes the registered PDU_Session_Id from the list of PDU Session with S-NSSAI_1 and decrements the counter of PDU Sessions being established to S-NSSAI_1.

5) Nsmn/nssf_SMN/NSSF_Deregister_Response—The SMN 720/NSSF 750 responds to the SMF 770 after successful operation.

6) Nsmf_PDUSession_UpdateSMContext Response—The SMF 770 confirms the PDU Session release to the AMF 710.

One example, step 3 to step 5 can be executed after the step 6.

Solution 3—Max number of UEs per Network Slice control

Aspect 1—Max UL and DL Data Rate Per UE in a Network Slice Control Via SMN 720/NSSF 750 During Service Request Procedure.

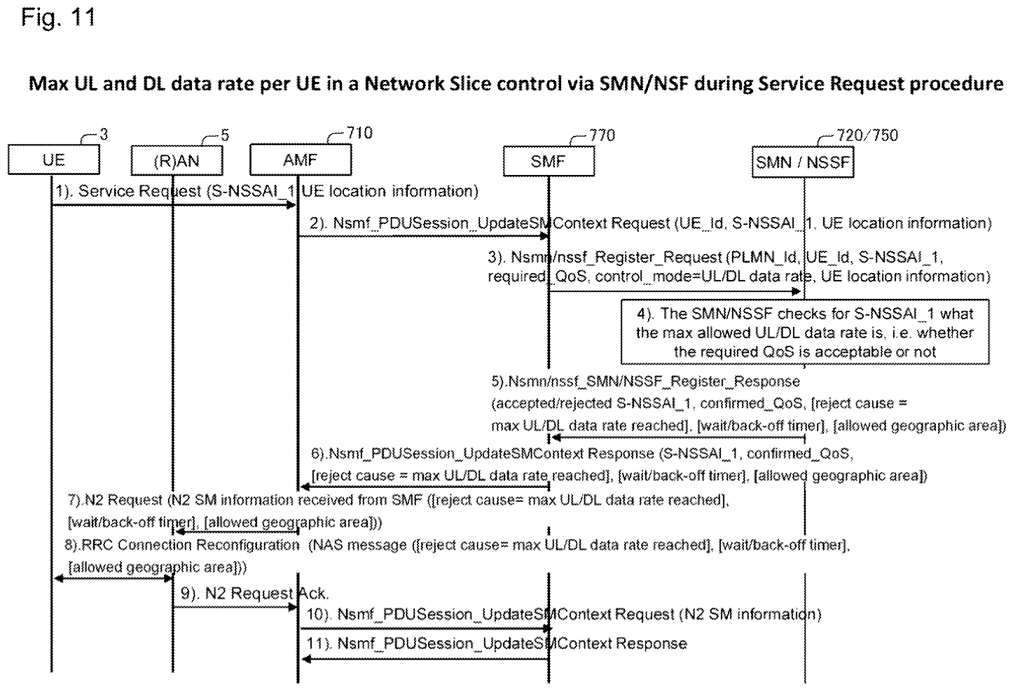

FIG. 11 is a schematic signalling (timing) diagram illustrating an exemplary method for controlling a maximum UL and DL data rate per UE in a Network Slice via the SMN 720/NSSF 750 during a Service Request procedure. In this example, the method includes the following steps:

1) Service Request (S-NSSAI_1, UE location information)—The UE 3 triggers a Service Request for Network Slice S-NSSAI_1. The UE 3 may include its location information in the UE location information parameter. UE location information is needed to check whether the UE 3 is allowed to initiate PDU Session establishment from its current location. The UE location information may be in the form of cell Id or list of Cell Ids (e.g. E-UTRAN Cell Identity (ECI), E-UTRAN Cell Global Identification (ECGI), NR Cell Identity (NCI) or NR Cell Global Identity (NCGI) or a set of them or a list of them) or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon or IP address and port number for non-3GPP access or any other way of UE location identification. Alternatively, the UE location information can be identified by GPS data. Also, the UE location information can be data which is determined based on any parameter described above or data which is determined by combination of any parameters described above. If no UE location information is provided by the AMF 710, for example Release 15 compliant UE, then the AMF 710 uses the EUTRA-CGI, TAI, IP address and port number for the N3IWF or NR-CGI in the INITIAL UE MESSAGE from the RAN to the AMF 710 as defined in 3GPP TS 38.413 [6].

2) Nsmf_PDUSession_UpdateSMContext Request (UE_Id, S-NSSAI_1, UE location information)—The AMF 710 selects a SMF 770 and requests SM context establishment.

3) The SMF 770 sends a Nsmn/nssf_Register_Request (PLMN_Id, UE_Id, S-NSSAI_1, required QoS, control_mode=UL/DL data rate, UE location information) in order to register the Upling and Downlink data rate for S-NSSAI_1. The SMF 770 sets the control_mode parameter to UP/DL data rate to indicate that the request is for control of UP/DL data rate per UE in S-NSSAI_1.

4) The SMN 720/NSSF 750 checks for S-NSSAI_1 what the max allowed UL/DL data rate is, i.e. whether the required QoS is acceptable or not.

5) Nsmn/nssf_SMN/NSSF_Register_Response (accepted/rejected S-NSSAI_1, confirmed_QoS, [reject cause=max UL/DL data rate reached], [wait/back-off timer], [allowed geographic area])

6) Nsmf_PDUSession_UpdateSMContext Response (S-NSSAI_1, confirmed_QoS, [reject cause=max UL/DL data rate reached], [wait/back-off timer], [allowed geographic area])

7) The AMF 710 sends a N2 Request (N2 SM information received from SMF 770 ([reject cause=max UL/DL data rate reached], [wait/back-off timer], [allowed geographic area])) message to the RAN.

8) The NG-RAN performs RRC Connection Reconfiguration with the UE 3. The RRC reconfiguration message from the RAN to UE 3 includes the NAS message (N2 SM information received from SMF 770 ([reject cause=max UL/DL data rate reached], [wait/back-off timer], [allowed geographic area])).

If the maximum Uplink and/or Downlink data rate for UE_ID in Network Slice S-NSSAI is not reached, the SMN 720/NSSF 750 returns the S-NSSAI_1 as accepted Network Slice, returns the a confirmed QoS which may be lower that the required QoS in step 3 depending of the aggregate level of the UP/DL data rate in the S-NSSAI_1 and may also return a geographic area within the allowed geographic area parameter. The allowed geographic area parameter allows the UE 3 to trigger PDU Session establishment for S-NSSAI_1 only in the allowed geographic area. The allowed geographic area may be in the form of cell Id or list of cell Ids or TA Id or list of TA Ids or in form of Ellipsoid Point, Ellipsoid Point with uncertainty Circle, Ellipsoid Point with uncertainty Ellipse, High Accuracy Ellipsoid point with uncertainty ellipse or Polygon. The cell Ids/list of cell Ids can be E-UTRAN Cell Identity (ECI), E-UTRAN Cell Global Identification (ECGI), NR Cell Identity (NCI) or NR Cell Global Identity (NCGI) or a set of them or a list of them. Alternatively, the geographic area can be identified by GPS data. Also, the geographic area can be data which is determined based on any parameter described above or data which is determined by combination of any parameters described above.

If the maximum Uplink and/or Downlink data rate per UE 3 in S-NSSAI_1 has been reached, the SMN 720/NSSF 750 returns a reject cause=max UP/DL data rate reached and the SMN 720 may also return a wait timer or back-off timer.

In which case the UE 3 shall not attempt another PDU Session establishment for S-NSSAI_1 while the wait/back-off timer is running

9) The (R)AN node 5 sends a N2 Request Ack (List of PDU Sessions To Be Established with N2 SM information (AN Tunnel Info, List of accepted QoS Flows for the PDU Sessions whose UP connections are activated, List of rejected QoS Flows for the PDU Sessions whose UP connections are activated), List of PDU Sessions that failed to be established with the failure cause given in the N2 SM information element) to the AMF 710.

10) The AMF 710 sends a Nsmf_PDUSession_UpdateSMContext Request (N2 SM information) to the SMF 770. If the N2 SM information requires to update the QoS Flows for the PDU sessions, the SMF 770 interworks with the associated UPFs. If one or some PDU sessions are failed in step 8) or accepted QoS Flow information has been changed from the one requested in step 8), then the SMF 770 may performs step 3) to step 5) in order to update the Max UL and DL data rate per UE information in the SMN 720/NSSF 750.

11) The SMF 770 sends a Nsmf_PDUSession_UpdateSMContext Response to the AMF 710.

Aspect 2—Max UL and DL Data Rate Per UE in a Network Slice Control Via SMN 720/NS SF 750 During RAN Connection Release

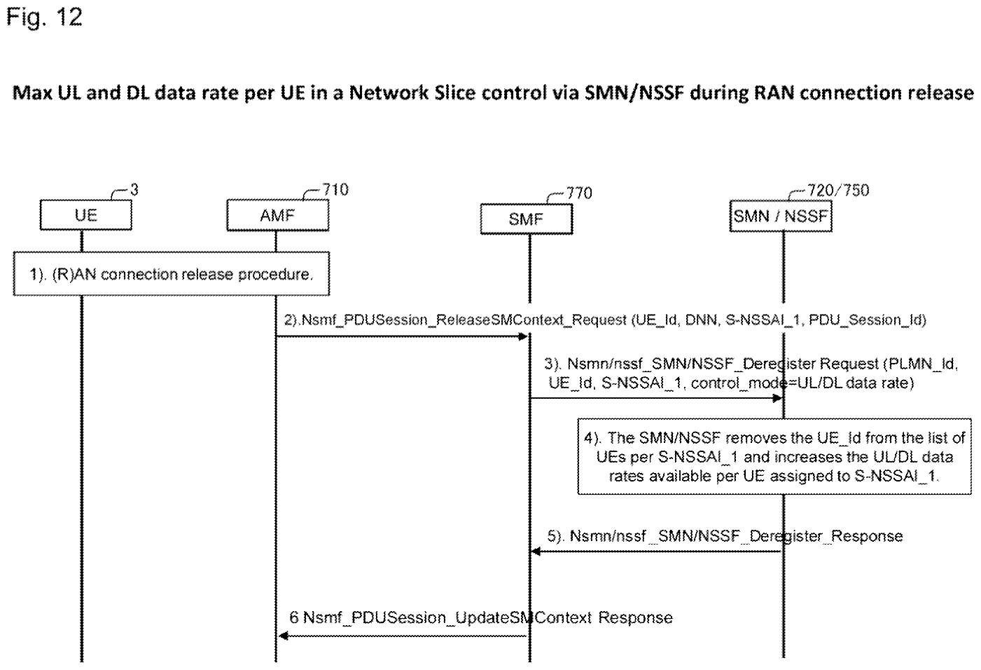

FIG. 12 is a schematic signalling (timing) diagram illustrating an exemplary method for controlling a maximum UL and DL data rate per UE in a Network Slice via the SMN 720/NSSF 750 during RAN connection release. In this example, the method includes the following steps:

1) (R)AN connection release procedure.

2) Nsmf_PDUSession_ReleaseSMContext_Request (UE_Id, DNN, S-NSSAI_1, PDU_Session_Id)—The AMF 710 requests the SMF 770 to release the SM session an include in the release message the UE_Id, DNN, the Network Slice S-NSSAI_1 and the PDU_Session_Id to be released.

3) Nsmn/nssf_SMN/NSSF_Deregister_Request (PLMN_Id, UE_Id, S-NSSAI_1, control mode=UP/DL data rate)—The SMF 770 requests increase for the UP/DL data rate per UE in Network Slice S-NSSAI_1 as the number of the PDU Sessions in that Network Slice will be decreased. The SMF 770 includes the control_mode parameter set to ‘UP/DL data rate’, i.e. the UP/DL data rate for S-NSSAI_1 is to be controlled.

4) The SMN 720/NSSF 750 removes the UE_Id from the list of UEs per S-NSSAI_1 and increases the UL/DL data rates available per UE assigned to S-NSSAI_1.

5) Nsmn/nssf_SMN/NSSF_Deregister_Response—The SMN 720/NSSF 750 responds to the SMF 770 after successful operation.

6) Nsmf_PDUSession_UpdateSMContext Response—The SMF 770 confirms the PDU Session release to the AMF 710.

### SUMMARY

Beneficially, the above described embodiments include, although they are not limited to, one or more of the following functionalities:

1) Monitoring and control the maximum number of the UEs registered in a Network Slice.

2) Monitoring and control the maximum number of the established PDU Sessions in a Network Slice.

3) Monitoring and control the maximum number of the Uplink and Downlink data rates per UE in a Network Slice.

4) Enforcing access and service restriction in a Network Slice when the Network Slice parameters boundaries have been reached.

5) New reject causes ‘max number UEs in S-NSSAI’, ‘max number of PDU Sessions in S-NSSAI’, ‘max number of UP/DL data rate per UE in S-NSSAI’ returned to the UE 3 to reject further access to the Network Slice.

6) New back-off timer return to the UE 3 to restrict the UE 3 access to the Network Slice for the duration of the back-off timer.

7) Allowed geographic area parameter returned to the UE 3 to restrict the access of the UE 3 to a Network Slice in a defined geographic location only.

Benefits

The above described embodiments allow for monitoring and control the maximum number of the UEs registered in a Network Slice, the maximum number of the established PDU Sessions in a Network Slice and the maximum number of the Uplink and Downlink data rates per UE in a Network Slice. The embodiments also make it possible to enforce access and service restriction in a Network Slice when the Network Slice parameters boundaries have been reached.

System Overview

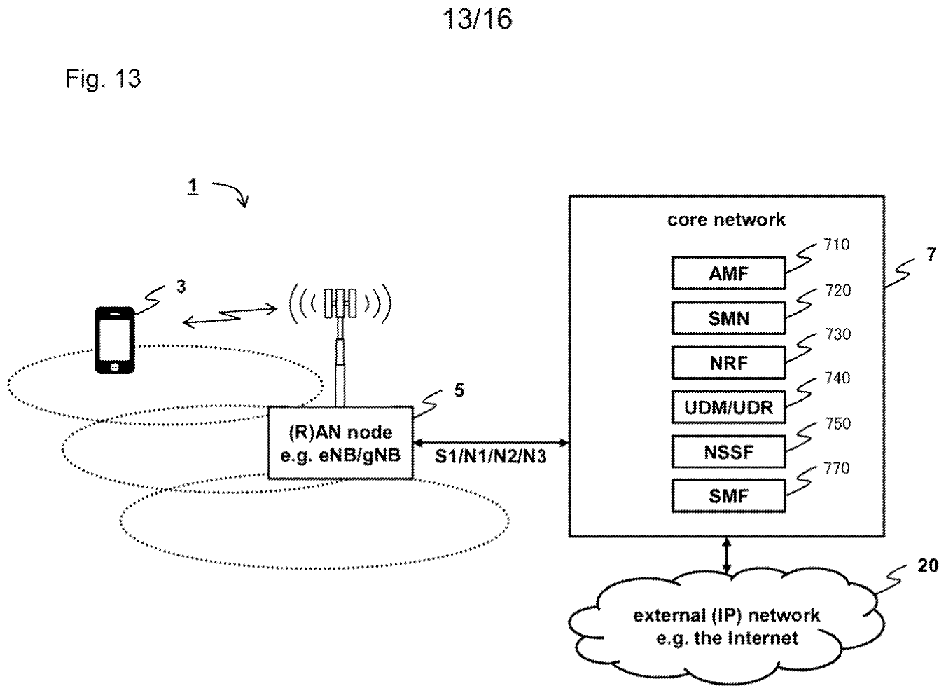

FIG. 13 schematically illustrates a mobile (cellular or wireless) telecommunication system 1 to which the above embodiments are applicable.

In this network, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst one mobile device 3 and one base station 5 are shown in FIG. 13 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports E-UTRA/4G protocols may be referred to as an ‘eNB’ and a base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘Uu’ interface and/or the like). Neighboring base stations 5 are connected to each other via an appropriate base station to base station interface (such as the so-called ‘X2’ interface, ‘Xn’ interface and/or the like). The base station 5 is also connected to the core network nodes via an appropriate interface (such as the so-called ‘S1’, ‘N1’, ‘N2’, ‘N3’ interface, and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) and user plane functions (UPFs). It will be appreciated that the core network 7 may also include, amongst others: an Access and Mobility Management Function (AMF) 710; a Slice Management Node (SMN) 720; a NF Repository Function (NRF) 730; a Unified Data Management (UDM)/Unified Data Repository (UDR) function 740; a Network Slice Selection Function (NSSF) 750; and a Session Management Function (SMF) 770.

From the core network 7, connection to an external IP network 20 (such as the Internet) is also provided.

The components of this system 1 are configured to perform one or more of the above described exemplary embodiments.

User Equipment (UE)

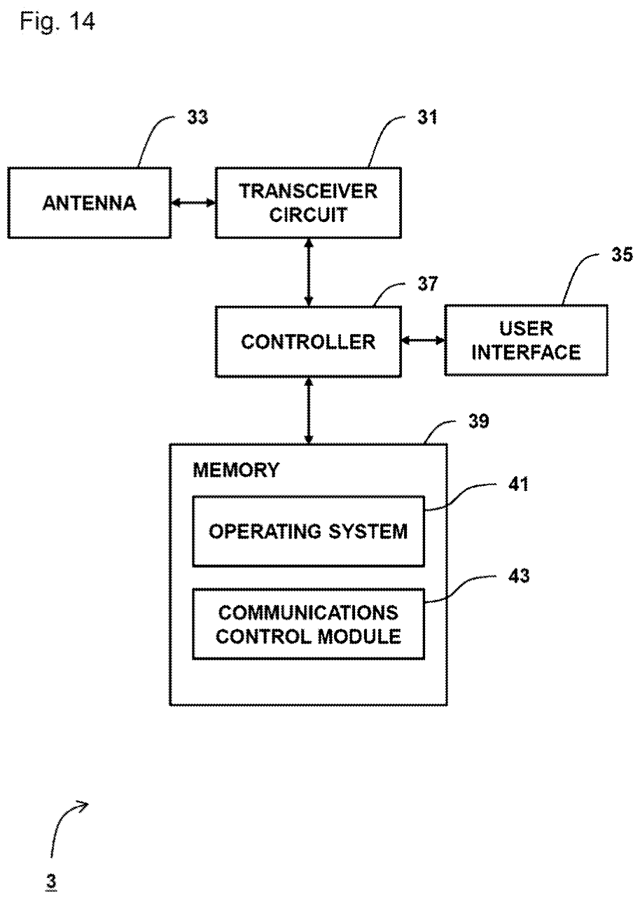

FIG. 14 is a block diagram illustrating the main components of the UE (mobile device 3) shown in FIG. 13. As shown, the UE includes a transceiver circuit 31 which is operable to transmit signals to and to receive signals from the connected node(s) via one or more antenna 33. Although not necessarily shown in FIG. 14, the UE will of course have all the usual functionality of a conventional mobile device (such as a user interface 35) and this may be provided by any one or any combination of hardware, software and firmware, as appropriate. A controller 37 controls the operation of the UE in accordance with software stored in a memory 39. The software may be pre-installed in the memory 39 and/or may be downloaded via the telecommunication network 1 or from a removable data storage device (RMD), for example. The software includes, among other things, an operating system 41 and a communications control module 43. The communications control module 43 is responsible for handling (generating/sending/receiving) signalling messages and uplink/downlink data packets between the UE 3 and other nodes, including (R)AN nodes 5, core network nodes, and application functions. Such signaling includes appropriately formatted requests and responses relating to controlling a maximum UL/DL data rate per UE in a Network Slice.

(R)AN Node

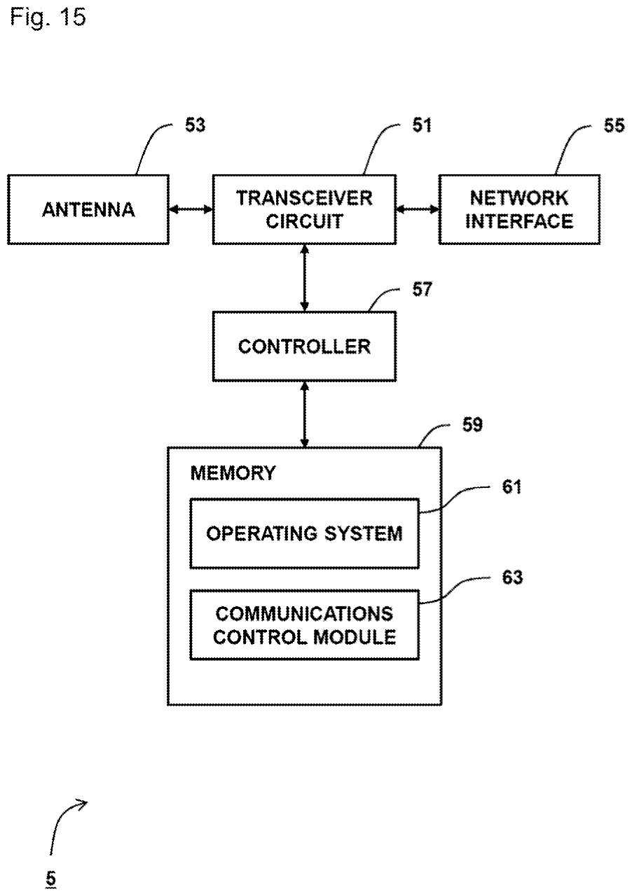

FIG. 15 is a block diagram illustrating the main components of an exemplary (R)AN node 5 (base station) shown in FIG. 13. As shown, the (R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station-core network interface (such as S1/N1/N2/N3). A controller 57 controls the operation of the (R)AN node 5 in accordance with software stored in a memory 59. The software may be pre-installed in the memory 59 and/or may be downloaded via the telecommunication network 1 or from a removable data storage device (RMD), for example. The software includes, among other things, an operating system 61 and a communications control module 63. The communications control module 63 is responsible for handling (generating/sending/receiving) signalling between the (R)AN node 5 and other nodes, such as the UE 3 and the core network nodes/AFs 12. Such signaling includes appropriately formatted requests and responses relating to controlling a maximum UL/DL data rate per UE in a Network Slice.

Core Network Node

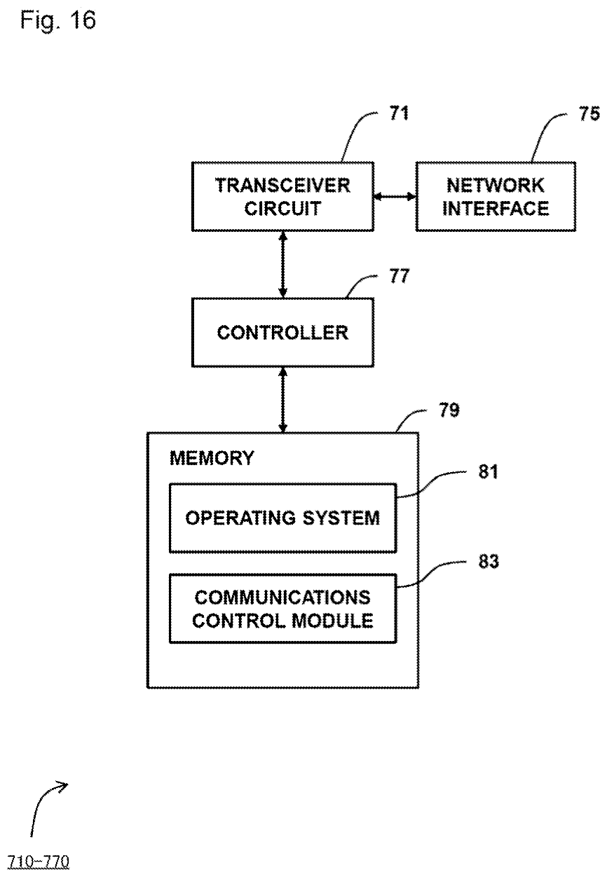

FIG. 16 is a block diagram illustrating the main components of a generic core network node (or function) shown in FIGS. 1 to 12, for example, the AMF 710, the SMN 720, the NRF 730, the UDM/UDR 740, the NSSF 750, and the SMF 770. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/receiving) signaling between the core network node and other nodes, such as the UE 3, (R)AN node 5, the AFs 12, and other core network nodes. Such signaling includes appropriately formatted requests and responses relating to controlling a maximum UL/DL data rate per UE in a Network Slice.

Modifications and Alternatives

Detailed embodiments have been described above. As those skilled in the art will appreciate, a number of modifications and alternatives can be made to the above embodiments whilst still benefiting from the disclosures embodied therein. By way of illustration only a number of these alternatives and modifications will now be described.

In the above description, the UE, the (R)AN node, and the core network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (TO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The above embodiments are also applicable to ‘non-mobile’ or generally stationary user equipment.

Various other modifications will be apparent to those skilled in the art and will not be described in further detail here.

### Abbreviations

3GPP 3rd Generation Partnership Project

5GC 5G Core Network

5GS 5G System

5G-AN 5G Access Network

5G-GUTISG Globally Unique Temporary Identity

5G-TMSI5G Temporary Mobile Subscriber Identity

AF Application Function

AMF Access and Mobility Management Function

AN Access Network

AS Access Stratum

AUSF Authentication Server Function

DDN Downlink Data Notification

DNN Data Network Name

gNB Next generation Note B

GPS Global Positioning System

GPSI Generic Public Subscriber Identity

GST Generic Slice Template

IMSI International Mobile Subscriber Identity

MSISDN Mobile Station International Subscriber Directory Number

MT Mobile Terminating

NAS Non-Access Stratum

NDA Non-Disclosure Agreement

NEF Network Exposure Function

NF Network Function

NG-RAN Next Generation Radio Access Network

NR New Radio

NRF NF Repository Function

NSSF Network Slice Selection Function

PCC Policy and Charging Control

PCF Policy Control Function

PDU Protocol Data Unit

PEI Permanent Equipment Identifier

PLMN Public land mobile network

QoS Quality of Service

(R)AN (Radio) Access Network

RRC Radio Resource Control

SM Session Management

SMF Session Management Function

SMN Slice Management Node

SUCI Subscription Concealed Identifier

SUPI Subscription Permanent Identifier

S-NSSAI Single Network Slice Selection Assistance Information

TA Tracking Area

TMSI Temporary Mobile Subscriber Identity

UDM Unified Data Management

UDR Unified Data Repository

UE User Equipment

### Definitions

For the purposes of the present document, the terms and definitions given in 3GPP Technical Report (TR) 21.905 [1] and the terms given in the present document apply. A term defined in the present document takes precedence over the definition of the same term, if any, in 3GPP TR 21.905 [1].

### CITATION LIST

### Non Patent Literature

[NPL 1] 3GPP TR 21.905: “Vocabulary for 3GPP Specifications”. V15.0.0 (2018-03)—https://www.3gpp.org/ftp/Specs/archive/21_series/21.905/21905-f00.zip
[NPL 2] 3GPP TS 23.501: “System Architecture for the 5G System; Stage 2”. V16.1.0 (2019-06)—http://www.3gpp.org/ftp/Specs/archive/23_series/23.501/23501-g10.zip
[NPL 3] 3GPP TS 23.502: “Procedures for the 5G System; Stage 2” V16.140 (2019-06)—http://www.3gpp.org/ftp/Specs/archive/23_series/23.502/23502-g10.zip
[NPL 4] Generic Network Slice Template—https://www.gsma.com/newsroom/wp-content/uploads/NG.116-v1.0.pdf
[NPL 5] SA2 SID on Enhancement of Network Slicing Phase 2 agreed in SA2#134 24-28 Jun. 2019, Sapporo, Japan —https://www.3gpp.org/ftp/tsg_sa/WG2_Arch/TS GS2_134 Sapporo/Docs/S2-1908583.zip
[NPL 6] 3GPP TS 38.413: “NG-RAN; NG Application Protocol (NGAP)”. V15.3.0 (2019-03) —https://www.3gpp.org/ftp/Specs/archive/38_series/38.413/38413-f30.zip

This application is based upon and claims the benefit of priority from European patent application No. 19185344.9, filed on Jul. 9, 2019, the disclosure of which is incorporated herein in its entirely by reference.

### REFERENCE SIGNS LIST

1 TELECOMMUNICATION SYSTEM
3 MOBILE DEVICE (UE)
31 TRANSCEIVER CIRCUIT
33 ANTENNA
35 USER INTERFACE
37 CONTROLLER
39 MEMORY
41 OPERATING SYSTEM
43 COMMUNICATION CONTROL MODULE
5 (R)AN NODE (gNB)
51 TRANSCEIVER CIRCUIT
53 ANTENNA
55 NETWORK INTERFACE
57 CONTROLLER
59 MEMORY
61 OPERATING SYSTEM
63 COMMUNICATION CONTROL MODULE
7 CORE NETWORK
71 TRANSCEIVER CIRCUIT
75 NETWORK INTERFACE
77 CONTROLLER
79 MEMORY
81 OPERATING SYSTEM
83 COMMUNICATION CONTROL MODULE
710 AMF
720 SMN
730 NRF
740 UDM/UDR
750 NSSF
760 NF
770 SMF
20 EXTERNAL IP NETWORK

What is claimed is:

1. A network node for network slice management, comprising:
a memory storing instructions; and
one or more processors configured to execute the instructions to:
receive a request regarding a network slice; and
determine whether the network node for network slice management rejects the request based on information regarding use of resource of the network slice.

2. The network node for network slice management according to claim 1, wherein
the determining including determining whether the network node for network slice management rejects the request based on whether a registered number of UEs for the network slice has reached a threshold.

3. The network node for network slice management according to claim 1, wherein
the determining including determining whether the network node for network slice management rejects the request based on whether an established number of Protocol Data Unit, PDU, sessions for the network slice has reached a threshold or not, and
the request is a request transmitted based on a PDU session establishment request.

4. The network node for network slice management according to claim 1, wherein
the determining including determining whether the network node for network slice management accepts the request based on whether data rate for at least one of downlink and uplink, the data rate being requested by the request, is allowable or not, and
the request includes a Service Request.

5-8. (canceled)

9. A method for a network node for network slice management, comprising:
receiving a request regarding a network slice; and
determining whether the network node for network slice management rejects the request based on information regarding use of resource of the network slice.

10. The method according to claim 9, wherein
the determining including determining whether the network node for network slice management rejects the request based on whether a registered number of UEs for the network slice has reached a threshold.

11. The method according to claim 9, wherein
the determining including determining whether the network node for network slice management rejects the request based on whether an established number of Protocol Data Unit, PDU, sessions for the network slice has reached a threshold or not, and
the request is a request transmitted based on a PDU session establishment request.

12. The method according to claim 9, wherein
the determining including determining whether the network node for network slice management accepts the request based on whether data rate for at least one of downlink and uplink, the data rate being requested by the request, is allowable or not, and
the request includes a Service Request.

13-16. (canceled)

17. User Equipment, comprising:
a memory storing instructions; and
one or more processors configured to execute the instructions to:
transmit a request regarding a network slice to a network node for mobility management; and
receive a response message for the request, from the network node, including a cause indicating that a count regarding use of resource of the network slice has reached to a threshold, wherein
the one or more processors are configured to not attempt to use an S-NSSAI (Single Network Slice Selection Assistance Information) based on the cause.

18. A method for User Equipment, comprising:
transmitting a request regarding a network slice to a network node for mobility management;
receiving a response message for the request, including a cause indicating that a count regarding use of resource of the network slice has reached to a threshold; and
not attempting to use an S-NSSAI (Single Network Slice Selection Assistance Information) based on the cause.
